(19) United States
(12) Patent Application Publication
(10) Pub. No.: US 2008/0042932 A1
(43) Pub. Date: Feb. 21, 2008

(54) PLASMA DISPLAY APPARATUS AND METHOD OF DRIVING THE SAME

(76) Inventors: Dongki PAIK, Seoul (KR); Jongrae Lim, Seoul (KR); Taeheon Kim, Seoul (KR); Wootae Kim, Seoul (KR); Sungchun Choi, Seoul (KR)

Correspondence Address: KED & ASSOCIATES, LLP, P.O. Box 221200, Chantilly, VA, 20153-1200, US

(21) Appl. No.: 11/840,351

(22) Filed: Aug. 17, 2007

(30) Foreign Application Priority Data
Aug. 18, 2006 (KR) 10-2006-0078414

(51) Int. Cl. G09G 3/28

(52) U.S. Cl. 345/60

(57) ABSTRACT

A plasma display apparatus and a method of driving the same are disclosed. The plasma display apparatus includes a drive integrated circuit (IC) supplying a driving voltage to a scan electrode, a scan reference voltage supply unit, a setup supply unit, and a sustain pulse supply unit. The scan reference voltage supply unit supplies a first voltage to the drive IC during a reset period, and supplies a scan reference voltage to the drive IC during an address period. The setup supply unit supplies a pulse gradually rising from the first voltage to a second voltage to the drive IC during the reset period. The sustain pulse supply unit supplies a sustain pulse having a negative sustain voltage to the drive IC during a sustain period.

This application claims the benefit of Korean Patent Application No. 10-2006-0078414 filed in Korea on Aug. 18, 2006, which is hereby incorporated by reference.

### BACKGROUND OF THE DISCLOSURE

1. Field of the Disclosure

This document relates to a display apparatus, and more particularly, to a plasma display apparatus and a method of driving the same.

2. Description of the Background Art

Out of display apparatuses, a plasma display apparatus includes a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) or a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

Recently, a plasma display apparatus has used a negative sustain driving method employing a low power. In the negative sustain driving method, an opposite discharge occurs between a scan electrode or a sustain electrode and an address electrode prior to the occurrence of a surface discharge between the scan electrode and the sustain electrode.

Charges generated by the opposite discharge functions as a seed charge of the surface discharge such that the surface discharge occurs smoothly.

In the related art negative sustain driving method, since a negative voltage is applied to the scan electrode and the sustain electrode positioned on a front substrate and a ground level voltage is applied to the address electrode, positive charges move toward the scan electrode and the sustain electrode. As a result, the positive charges collides with a protective layer made of MgO on the scan electrode and the sustain electrode, thereby emitting secondary electrons. The secondary electrons affect the following surface discharge. In other words, the secondary electrons function as a seed charge of the surface discharge, thereby smoothly generating the surface discharge.

The following is a description of a circuit for implementing the negative sustain driving method of the plasma display apparatus, with reference to FIG. 1.

FIG. 1 illustrates a related art plasma display apparatus.

As illustrated in FIG. 1, the related art plasma display apparatus includes an energy recovery circuit unit 100, a setup supply unit 110, a scan reference voltage supply unit 120, a drive integrated circuit (IC) unit 130, a set-down supply unit 140 and a scan voltage supply unit 150. The related art plasma display apparatus further includes a sixth switch Q6 connected between the energy recovery circuit unit 100 and the setup supply unit 110, and a seventh switch Q7 connected between the setup supply unit 110 and the drive IC 130.

However, the circuit of FIG. 1 for implementing the negative sustain driving method is designed to raise a rising pulse from a ground level voltage GND to a high setup voltage without the supply of a setup bias voltage during a setup period of a reset period. Therefore, it is not easy that the circuit of FIG. 1 drives a plasma display panel having a long-gap structure, in which a distance between a scan electrode requiring a high setup voltage and a sustain electrode is long.

To solve such a problem, the high setup voltage may be applied to the scan electrode with the supply of the setup bias voltage. However, in such a case, a separate voltage source for supplying the setup bias voltage is required, thereby causing an increase in the fabrication cost.

Further, the sixth switch Q6 used as a high voltage pass bottom switch is expensive, thereby causing an increase in the fabrication cost.

### SUMMARY OF THE DISCLOSURE

Accordingly, this document provides a plasma display apparatus and a method of driving the same capable of simplifying a configuration of a circuit constituting the plasma display apparatus and reducing the fabrication cost thereof.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one aspect, a plasma display apparatus comprises a plasma display panel including a scan electrode and a sustain electrode, a drive integrated circuit (IC) that supplies a driving voltage to the scan electrode, a scan reference voltage supply unit that supplies a first voltage to the drive IC during a reset period, and supplies a scan reference voltage to the drive IC during an address period, a setup supply unit that supplies a pulse gradually rising from the first voltage to a second voltage to the drive IC during the reset period, and a sustain pulse supply unit that supplies a sustain pulse of a negative polarity having a negative sustain voltage to the drive IC during a sustain period.

The drive IC may comprise a top switch and a bottom switch. One terminal of the setup supply unit may be connected to a common terminal of the scan reference voltage supply unit and the top switch of the drive IC.

An absolute value of the first voltage may be substantially equal to an absolute value of the scan reference voltage.

The scan reference voltage may be a negative voltage level.

The setup supply unit may comprise a variable resistor.

A distance between the scan electrode and the sustain electrode may range from 100 μm to 400 μm.

In another aspect, a plasma display apparatus comprises a plasma display panel including a scan electrode and a sustain electrode, a drive integrated circuit (IC) that supplies a driving voltage to the scan electrode, a scan reference voltage supply unit that supplies a first voltage to the drive IC during a reset period, and supplies a scan reference voltage to the drive IC during an address period, a setup supply unit that supplies a pulse gradually rising from the first voltage to a second voltage to the drive IC during the reset period, a first sustain pulse supply unit that supplies a sustain pulse of a negative polarity having a negative sustain voltage to the drive IC during a sustain period, and a second sustain pulse supply unit that supplies a sustain pulse of a negative polarity having a negative sustain voltage to the sustain electrode during the sustain period, and supplies a ground level voltage to the sustain electrode during the reset period and the address period.

The drive IC may comprise a top switch and a bottom switch. One terminal of the setup supply unit may be connected to a common terminal of the scan reference voltage supply unit and the top switch of the drive IC.

An absolute value of the first voltage may be substantially equal to an absolute value of the scan reference voltage.

The scan reference voltage may be a negative voltage level.

The setup supply unit may comprise a variable resistor.

The plasma display apparatus may further comprise a set-down supply unit that supplies a pulse gradually falling from a ground level voltage to a third voltage to the drive IC.

The third voltage may substantially range from −800V to −300V.

A distance between the scan electrode and the sustain electrode may range from 100 μm to 400 μm.

In still another aspect, a method of driving a plasma display apparatus comprises supplying a pulse, which rises to a first voltage and then rises from the first voltage to a second voltage with a predetermined slope, to a scan electrode during a reset period, supplying a scan reference voltage to the scan electrode during an address period, supplying a ground level voltage to a sustain electrode during the reset period and the address period, and alternately supplying a sustain pulse of a negative polarity to the scan electrode and the sustain electrode during a sustain period.

An absolute value of the first voltage may be substantially equal to an absolute value of the scan reference voltage.

The scan reference voltage may be a negative voltage level.

The method may further comprise after supplying the pulse, which rises to the first voltage and then rises from the first voltage to the second voltage with the predetermined slope to the scan electrode, supplying a pulse gradually falling from a ground level voltage to a third voltage to the scan electrode during the reset period.

The third voltage may substantially range from −800V to −300V.

A distance between the scan electrode and the sustain electrode may range from 100 μm to 400 μm.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a related art plasma display apparatus;

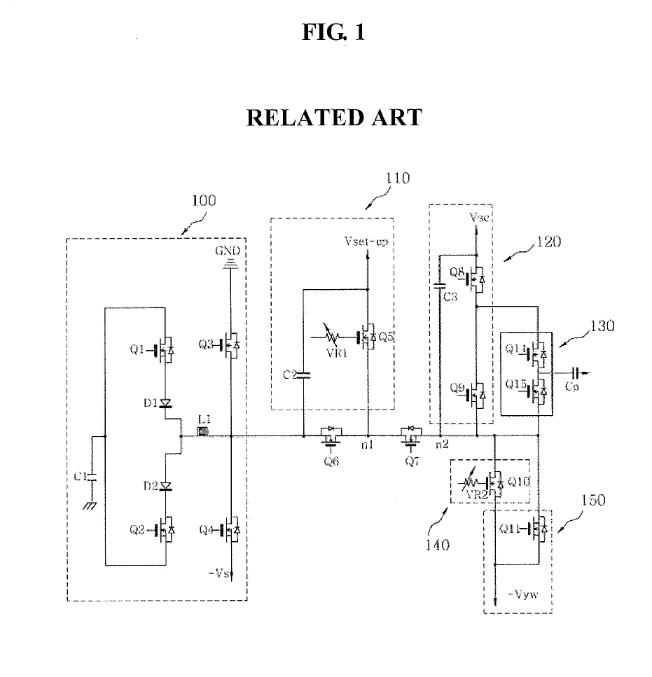

FIG. 2 illustrates the structure of a plasma display panel of a plasma display apparatus according to an exemplary embodiment;

FIG. 3 illustrates a plasma display apparatus according to an exemplary embodiment;

FIG. 4 illustrates a driving waveform generated by a plasma display apparatus according to an exemplary embodiment;

FIG. 5 illustrates a plasma display apparatus according to another exemplary embodiment; and

FIG. 6 illustrates a driving waveform generated by a plasma display apparatus according to another exemplary embodiment.

### DETAILED DESCRIPTION OF EMBODIMENTS

Reference will now be made in detail embodiments of the invention examples of which are illustrated in the accompanying drawings.

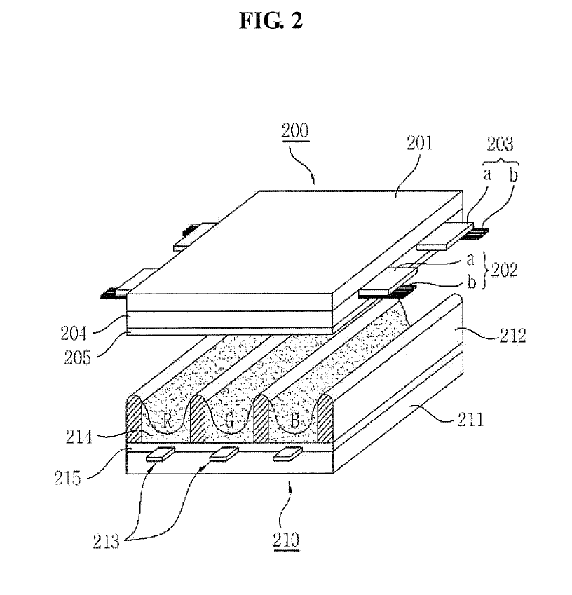

FIG. 2 illustrates the structure of a plasma display panel of a plasma display apparatus according to an exemplary embodiment.

As illustrated in FIG. 2, a plasma display panel of a plasma display apparatus according to an exemplary embodiment includes a front panel 200 and a rear panel 210 which are coupled in parallel to oppose to each other at a given distance therebetween. The front panel 200 includes a front substrate 201 being a display surface on which an image is displayed. The rear panel 210 includes a rear substrate 211 constituting a rear surface. A plurality of scan electrodes 202 and a plurality of sustain electrodes 203 are formed in pairs on the front substrate 201. A plurality of address electrodes 213 are arranged on the rear substrate 211 to intersect the scan electrodes 202 and the sustain electrodes 203.

The scan electrode 202 and the sustain electrode 203 each include transparent electrodes 202a and 203a made of a transparent material, for instance, indium-tin-oxide (ITO) and bus electrodes 202b and 203b made of a metal material. The scan electrode 202 and the sustain electrode 203 generate a mutual discharge therebetween in one discharge cell and maintain light-emissions of the discharge cells.

The scan electrode 202 and the sustain electrode 203 are covered with one or more upper dielectric layers 204 for limiting a discharge current and providing electrical insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are formed in parallel on the rear substrate 211 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear substrate 211 is coated with red (R), green (G) and blue (B) phosphors 214 for emitting visible light for an image display during the generation of an address discharge. A lower dielectric layer 215 is formed between the address electrodes 213 and the phosphors 214 to protect the address electrodes 213.

FIG. 2 illustrated only an example of the plasma display panel applicable to an exemplary embodiment. Accordingly, an exemplary embodiment is not limited to the structure of the plasma display panel illustrated in FIG. 2.

For instance, in FIG. 2, the scan electrode 202 and the sustain electrode 203 each include the transparent electrodes 202a and 203a and the bus electrodes 202b and 203b. However, at least one of the scan electrode 202 and the sustain electrode 203 may include either the bus electrode or the transparent electrode.

Further, FIG. 2 illustrated and described the structure of the plasma display panel in which the front panel 200 includes the scan electrode 202 and the sustain electrode 203 and the rear panel 210 includes the address electrode 213. However, the front panel 200 may include all of the scan electrode 202, the sustain electrode 203, and the address electrode 213. At least one of the scan electrode 202, the sustain electrode 203, and the address electrode 213 may be formed on the barrier rib 212.

Considering the structure of the plasma display panel illustrated in FIG. 2, the plasma display panel applicable to an exemplary embodiment has only to include the scan electrode 202, the sustain electrode 203 and the address electrode 213. Accordingly, the plasma display panel according to an exemplary embodiment can be variously changed except the above-described structural characteristic.

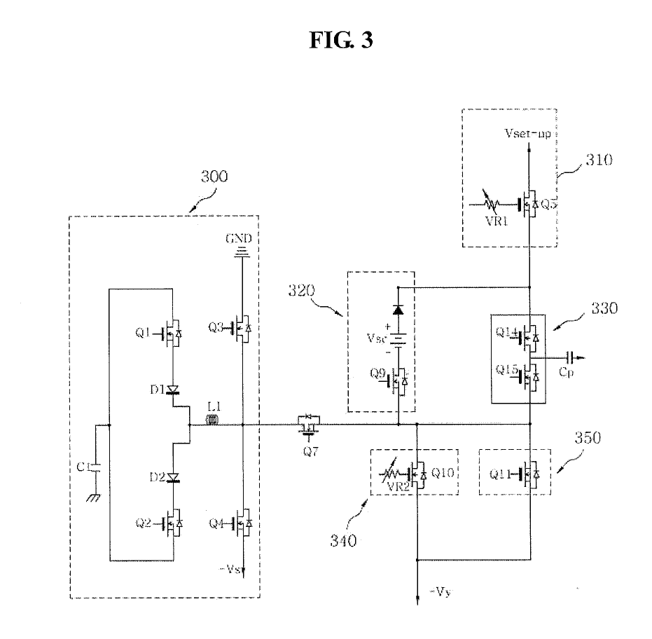

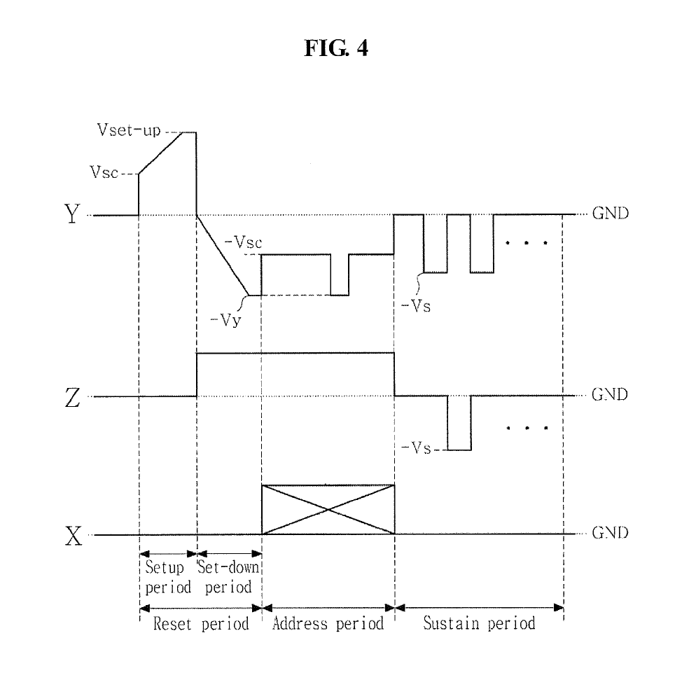

FIG. 3 illustrates a plasma display apparatus according to an exemplary embodiment. FIG. 4 illustrates a driving waveform generated by a plasma display apparatus according to an exemplary embodiment.

As illustrated in FIGS. 3 and 4, the plasma display apparatus according to an exemplary embodiment includes a sustain pulse supply unit 300, a setup supply unit 310, a scan reference voltage supply unit 320, a drive integrated circuit (IC) unit 330, a set-down supply unit 340, and a scan voltage supply unit 350.

The sustain pulse supply unit 300 includes a first capacitor C1, a first inductor L1, and first to fourth switches Q1 to Q4. During a sustain period, the sustain pulse supply unit 300 recovers a voltage stored in a scan electrode Y of a plasma display panel Cp through resonance between the sustain pulse supply unit 300 and the plasma display panel Cp. The sustain pulse supply unit 300 supplies the recovered voltage to the scan electrode Y of the plasma display panel Cp, and supplies a negative sustain voltage −Vs to the drive IC 330.

Accordingly, the drive IC 330 receives a sustain pulse of a negative polarity having the negative sustain voltage −Vs.

The setup supply unit 310 includes a setup voltage source Vset-up, a first variable resistor VR1, and a fifth switch Q5. One terminal of the setup supply unit 310 is commonly connected to the scan reference voltage supply unit 320 and a top switch Q14 of the drive IC 330. Hence, a pulse (i.e., a setup pulse) gradually rising from a first voltage Vsc to a second voltage Vset-up is supplied to the drive IC 330 during a setup period of a reset period.

Since the fifth switch Q5 performs an inverse current blocking function when the second voltage Vset-up is applied, the related art high voltage pass bottom switch Q6 can be removed.

Accordingly, the plasma display apparatus according to an exemplary embodiment can be more efficiently driven while reducing the fabrication cost due to the removal of the expensive high voltage pass bottom switch Q6.

The scan reference voltage supply unit 320 includes a scan reference voltage source Vsc and a ninth switch Q9. The scan reference voltage supply unit 320 supplies the first voltage Vsc, which is a setup bias voltage, to the drive IC 330 during the reset period, and supplies a scan reference voltage −Vsc to the drive IC 330 during an address period.

An absolute value of the first voltage Vsc is substantially equal to an absolute value of the scan reference voltage −Vsc. A polarity of the first voltage Vsc is opposite to a polarity of the scan reference voltage −Vsc. In other words, the polarity of the scan reference voltage −Vsc is a negative polarity.

As above, the scan reference voltage source Vsc of the scan reference voltage supply unit 320 supplies both the first voltage Vsc, which is the setup bias voltage, and the scan reference voltage −Vsc. Accordingly, the setup pulse having the setup bias voltage Vsc (i.e., the first voltage) can be supplied to the scan electrode Y without a separate voltage source.

The drive IC 330 includes the top switch Q14 and a bottom switch Q15. The drive IC 330 supplies driving voltages supplied from the sustain pulse supply unit 300, the setup supply unit 310, the scan reference voltage supply unit 320, the set-down supply unit 340, and the scan voltage supply unit 350 to the scan electrode Y of the plasma display panel Cp.

The set-down supply unit 340 includes a second variable resistor VR2 and a tenth switch Q10. The set-down supply unit 340 supplies a pulse (i.e., a set-down pulse) gradually falling from a ground level voltage GND to a third voltage −Vy to the drive IC 330 during a set-down period of the reset period.

The scan voltage supply unit 350 includes an eleventh switch Q11. The scan voltage supply unit 350 supplies a scan voltage −Vy (i.e., the third voltage −Vy) to the drive IC 330 during the address period.

Operations of the plasma display apparatus according to an exemplary embodiment having the above-described circuit configuration will be described in detail, with reference to FIG. 4.

During the setup period, the top switch Q14 of the drive IC 330 is turned on. Due to the turned-on top switch Q14, the first voltage Vsc is supplied to the scan electrode Y of the plasma display panel Cp.

During the setup period, the fifth switch Q5 of the setup supply unit 310 is turned on and the top switch Q14 remains in a turn-on state. Hence, the first variable resistor VR1 installed in the front of the fifth switch Q5 controls a channel width, and the setup pulse gradually rising from the first voltage Vsc to the second voltage Vset-up is supplied to the scan electrode Y of the plasma display panel Cp.

During the set-down period, the fifth switch Q5 and the top switch Q14 are turned off, and the tenth switch Q10 of the set-down supply unit 340 is turned on. Hence, the second variable resistor VR2 installed in the front of the tenth switch Q10 controls a channel width, and the set-down pulse gradually falling from the ground level voltage GND to the third voltage −Vy is supplied to the scan electrode Y of the plasma display panel Cp.

During the address period, the ninth switch Q9 of the scan reference voltage supply unit 320 and the bottom switch Q15 of the drive IC 330 are turned on. Hence, the scan reference voltage −Vsc is supplied to the scan electrode Y of the plasma display panel Cp.

During the address period, the ninth switch Q9 is turned off and the eleventh switch Q11 of the scan voltage supply unit 350 is turned on. Hence, the scan voltage −Vy is supplied to the scan electrode of the plasma display panel Cp.

During the sustain period, the sustain pulse of the negative polarity having the negative sustain voltage −Vs is supplied to the scan electrode of the plasma display panel Cp through switching operations of the first to fourth switches Q1 to Q4 of the sustain pulse supply unit 300.

The plasma display apparatus according to an exemplary embodiment can drive a plasma display panel having a long-gap structure in which a distance between a scan electrode and a sustain electrode is long.

More specifically, in case of using a plasma display panel having a long-gap structure, in which a distance between a scan electrode and a sustain electrode substantially ranges from 100 μm to 400 μm, used to improve discharge efficiency and to stabilize a driving characteristic, the plasma display apparatus according to an exemplary embodiment can more efficiently and more stably drive the plasma display panel having the long-gap structure.

Further, the time allotted for the reset period can be reduced by applying a high setup voltage to the plasma display panel having the long-gap structure.

A distance between the scan electrode and the sustain electrode may substantially range from 160 μm to 300 μm.

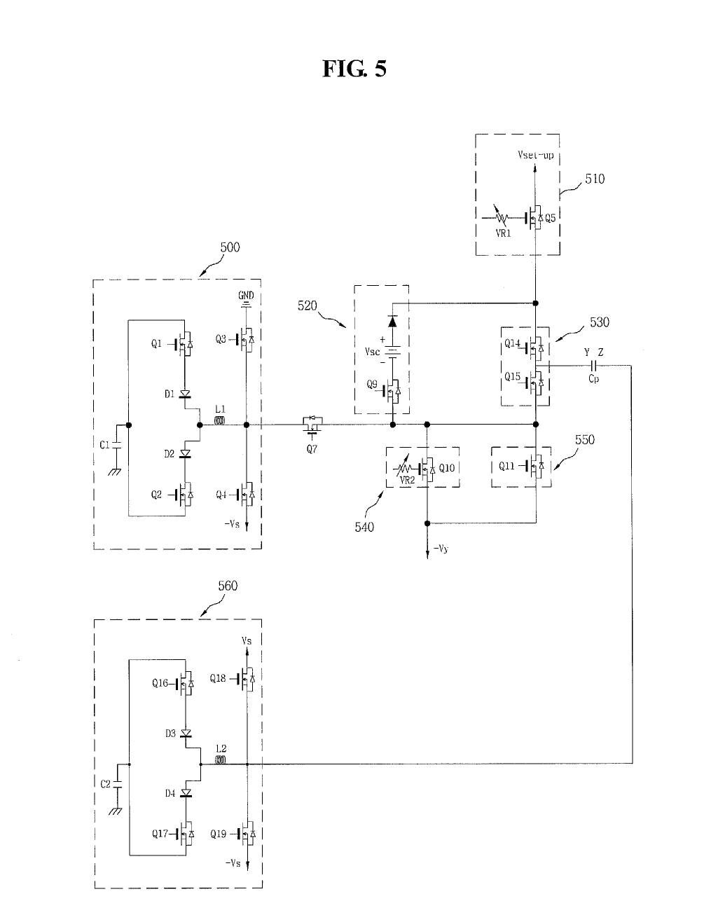

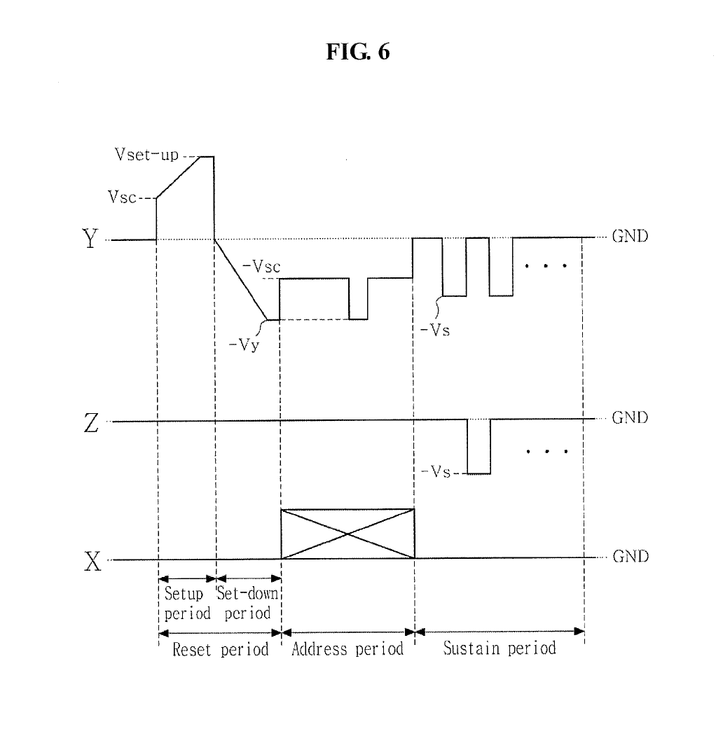

FIG. 5 illustrates a plasma display apparatus according to another exemplary embodiment. FIG. 6 illustrates a driving waveform generated by a plasma display apparatus according to another exemplary embodiment.

Since a configuration and operations of the plasma display apparatus according to another exemplary embodiment illustrated in FIGS. 5 and 6 are substantially the same as the configuration and the operations of the plasma display apparatus according to an exemplary embodiment illustrated in FIGS. 3 and 4 except a second sustain pulse supply unit 560, a description thereof will be omitted.

As illustrated FIG. 5, the second sustain pulse supply unit 560 includes a second capacitor C2, a second inductor L2, and sixteenth to nineteenth switches Q16 to Q19. During a sustain period, the second sustain pulse supply unit 560 recovers a voltage stored in a sustain electrode Z of a plasma display panel Cp through resonance between the second sustain pulse supply unit 560 and the plasma display panel Cp. The second sustain pulse supply unit 560 supplies the recovered voltage to the sustain electrode Z of the plasma display panel Cp, and supplies a negative sustain voltage −Vs to the sustain electrode Z of the plasma display panel Cp.

Accordingly, a sustain pulse of a negative polarity having the negative sustain voltage −Vs is supplied to the sustain electrode Z of the plasma display panel Cp. During a reset period and an address period, a ground level voltage GND is supplied to the sustain electrode Z.

A setup pulse supplied to a scan electrode Y of the plasma display panel Cp rises from a setup bias voltage (i.e., a first voltage Vsc) in the plasma display apparatus according to another exemplary embodiment. Therefore, it is not necessary to supply a bias voltage corresponding to the setup pulse to the sustain electrode Z.

Accordingly, a circuit for driving the sustain electrode Z may be designed to a simple sustain circuit including only the second sustain pulse supply unit 560. Further, the driving circuit of the sustain electrode Z and the driving circuit of the scan electrode Y may be integrated into one driving circuit, thereby simplifying the circuit configuration of the plasma display apparatus and reducing the fabrication cost.

As illustrated in FIG. 6, when a set-down pulse gradually falling from a ground level voltage GND to a third voltage −Vy is supplied to the scan electrode Y, a voltage of the scan electrode Y falls toward a negative voltage level until a weak discharge occurs. Therefore, the ground level voltage GND supplied to the sustain electrode Z during the reset period does not affect a discharge.

The third voltage −vy may substantially range from −800V to −300V. In such a case, the plasma display apparatus according to another exemplary embodiment can drive a plasma display panel having the long-gap structure.

The plasma display apparatus according to exemplary embodiments supplies the setup pulse having the setup bias voltage without a separate voltage source, thereby improving a driving characteristic and reducing the fabrication cost.

Embodiments of the invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A plasma display apparatus comprising:
a plasma display panel including a scan electrode and a sustain electrode;
a drive integrated circuit (IC) that supplies a driving voltage to the scan electrode;
a scan reference voltage supply unit that supplies a first voltage to the drive IC during a reset period, and supplies a scan reference voltage to the drive IC during an address period;
a setup supply unit that supplies a pulse gradually rising from the first voltage to a second voltage to the drive IC during the reset period; and
a sustain pulse supply unit that supplies a sustain pulse of a negative polarity having a negative sustain voltage to the drive IC during a sustain period.

2. The plasma display apparatus of claim 1, wherein the drive IC comprises a top switch and a bottom switch, and one terminal of the setup supply unit is connected to a common terminal of the scan reference voltage supply unit and the top switch of the drive IC.

3. The plasma display apparatus of claim 1, wherein an absolute value of the first voltage is substantially equal to an absolute value of the scan reference voltage.

4. The plasma display apparatus of claim 1, wherein the scan reference voltage is a negative voltage level.

5. The plasma display apparatus of claim 1, wherein the setup supply unit comprises a variable resistor.

6. The plasma display apparatus of claim 1, wherein a distance between the scan electrode and the sustain electrode ranges from 100 μm to 400 μm.

7. A plasma display apparatus comprising:
a plasma display panel including a scan electrode and a sustain electrode;
a drive integrated circuit (IC) that supplies a driving voltage to the scan electrode;
a scan reference voltage supply unit that supplies a first voltage to the drive IC during a reset period, and supplies a scan reference voltage to the drive IC during an address period;
a setup supply unit that supplies a pulse gradually rising from the first voltage to a second voltage to the drive IC during the reset period;
a first sustain pulse supply unit that supplies a sustain pulse of a negative polarity having a negative sustain voltage to the drive IC during a sustain period; and
a second sustain pulse supply unit that supplies a sustain pulse of a negative polarity having a negative sustain voltage to the sustain electrode during the sustain period, and supplies a ground level voltage to the sustain electrode during the reset period and the address period.

8. The plasma display apparatus of claim 7, wherein the drive IC comprises a top switch and a bottom switch, and
one terminal of the setup supply unit is connected to a common terminal of the scan reference voltage supply unit and the top switch of the drive IC.

9. The plasma display apparatus of claim 7, wherein an absolute value of the first voltage is substantially equal to an absolute value of the scan reference voltage.

10. The plasma display apparatus of claim 7, wherein the scan reference voltage is a negative voltage level.

11. The plasma display apparatus of claim 7, wherein the setup supply unit comprises a variable resistor.

12. The plasma display apparatus of claim 7, further comprising a set-down supply unit that supplies a pulse gradually falling from a ground level voltage to a third voltage to the drive IC.

13. The plasma display apparatus of claim 12, wherein the third voltage substantially ranges from −800V to −300V.

14. The plasma display apparatus of claim 7, wherein a distance between the scan electrode and the sustain electrode ranges from 100 μm to 400 μm.

15. A method of driving a plasma display apparatus comprising:
supplying a pulse, which rises to a first voltage and then rises from the first voltage to a second voltage with a predetermined slope, to a scan electrode during a reset period;
supplying a scan reference voltage to the scan electrode during an address period;
supplying a ground level voltage to a sustain electrode during the reset period and the address period; and
alternately supplying a sustain pulse of a negative polarity to the scan electrode and the sustain electrode during a sustain period.

16. The method of claim 15, wherein an absolute value of the first voltage is substantially equal to an absolute value of the scan reference voltage.

17. The method of claim 15, wherein the scan reference voltage is a negative voltage level.

18. The method of claim 15, further comprising, after supplying the pulse, which rises to the first voltage and then rises from the first voltage to the second voltage with the predetermined slope to the scan electrode, supplying a pulse gradually falling from a ground level voltage to a third voltage to the scan electrode during the reset period.

19. The method of claim 18, wherein the third voltage substantially ranges from −800V to −300V.

20. The method of claim 15, wherein a distance between the scan electrode and the sustain electrode ranges from 100 μm to 400 μm.
